(19) United States
(12) Patent Application Publication
(10) Pub. No.: US 2026/0133710 A1
(43) Pub. Date: May 14, 2026

(54) SYSTEM AND METHOD FOR WEIGHTED ALLOCATION TO STORAGE DEVICES

(71) Applicant: Samsung Electronics Co., Ltd., Suwon-si (KR)

(72) Inventors: Ramachaitanya KAVULURU, Santa Clara, CA (US); Somnath ROY, San Ramon, CA (US); Benixon ARUL DHAS, Gilroy, CA (US); Harsh ROOGI, Pleasanton, CA (US)

(21) Appl. No.: 19/070,442

(22) Filed: Mar. 4, 2025

Related U.S. Application Data
(60) Provisional application No. 63/718,969, filed on Nov. 11, 2024.

(51) Int. Cl. G06F 3/06

(52) U.S. Cl. CPC G06F 3/0631; G06F 3/0604; G06F 3/0683

(57) ABSTRACT

A system and method for weighted allocation to storage devices. In some embodiments, the method includes: storing a slice in a storage system, the storage system including a first storage device and a second storage device, the storing of the slice including: storing a first number of segments of the slice in the first storage device, and storing a second number of segments of the slice in the second storage device, the first number being based on a first weight, associated with the first storage device, the second number being based on a second weight, associated with the second storage device, and the second weight being different from the first weight.

### CROSS-REFERENCE TO RELATED APPLICATION(S)

The present application claims priority to and the benefit of U.S. Provisional Application No. 63/718,969, filed Nov. 11, 2024, entitled “WEIGHTED ROUND ROBIN MECHANISM FOR STATICALLY MAPPED VOLUME”, the entire content of which is incorporated herein by reference.

### FIELD

One or more aspects of embodiments according to the present disclosure relate to data storage, and more particularly to a system and method for weighted allocation to storage devices.

### BACKGROUND

A computing system may include a host device and persistent storage. The persistent storage may include a plurality of storage devices, which may have different characteristics.

It is with respect to this general technical environment that aspects of the present disclosure are related.

### SUMMARY

According to an embodiment of the present disclosure, there is provided a method, including: storing a slice in a storage system, the storage system including a first storage device and a second storage device, the storing of the slice including: storing a first number of segments of the slice in the first storage device, and storing a second number of segments of the slice in the second storage device, the first number being based on a first weight, associated with the first storage device, the second number being based on a second weight, associated with the second storage device, and the second weight being different from the first weight.

In some embodiments, a ratio of the second number to the first number is equal to a ratio of the second weight to the first weight.

In some embodiments, a ratio of the first weight to the second weight is within 20% of a ratio of a size of the first storage device to a size of the second storage device.

In some embodiments, the storage system is a statically mapped storage system.

In some embodiments: the first storage device has a first size, the second storage device has a second size; and the second size is greater than 1.5 times the first size.

In some embodiments, the first storage device includes a first storage medium, and the second storage device includes a second storage medium different from the first storage medium.

In some embodiments: the storage system further includes a third storage device; the storing of the slice further includes storing a third number of segments of the slice in the second storage device; the third number is based on a third weight, associated with the third storage device; the third weight is different from the first weight; and the third weight is different from the second weight.

According to an embodiment of the present disclosure, there is provided a system, including: a storage control circuit; a first storage device; and a second storage device, the storage control circuit having a host interface for making a connection to a host, the storage control circuit being configured to store a slice, the storing of the slice including: storing a first number of segments of the slice in the first storage device, and storing a second number of segments of the slice in the second storage device, the first number being based on a first weight, associated with the first storage device, the second number being based on a second weight, associated with the second storage device, and the second weight being different from the first weight.

In some embodiments, a ratio of the second number to the first number is equal to a ratio of the second weight to the first weight.

In some embodiments, a ratio of the first weight to the second weight is within 20% of a ratio of a size of the first storage device to a size of the second storage device.

In some embodiments: the first storage device has a first size, the second storage device has a second size; and the second size is greater than 1.5 times the first size.

In some embodiments, the first storage device includes a first storage medium, and the second storage device includes a second storage medium different from the first storage medium.

In some embodiments, the system further includes a third storage device, wherein: the storing of the slice further includes storing a third number of segments of the slice in the second storage device; the third number is based on a third weight, associated with the third storage device; the third weight is different from the first weight; and the third weight is different from the second weight.

According to an embodiment of the present disclosure, there is provided a system, including: a host; a first storage device; and a second storage device, the host including a processing circuit, the processing circuit being configured to store a slice, the storing of the slice including: storing a first number of segments of the slice in the first storage device, and storing a second number of segments of the slice in the second storage device, the first number being based on a first weight, associated with the first storage device, the second number being based on a second weight, associated with the second storage device, and the second weight being different from the first weight.

In some embodiments, a ratio of the second number to the first number is equal to a ratio of the second weight to the first weight.

In some embodiments, a ratio of the first weight to the second weight is within 20% of a ratio of a size of the first storage device to a size of the second storage device.

In some embodiments: the first storage device has a first size, the second storage device has a second size; and the second size is greater than 1.5 times the first size.

In some embodiments, the first storage device includes a first storage medium, and the second storage device includes a second storage medium different from the first storage medium.

In some embodiments, the system further includes a third storage device, wherein: the storing of the slice further includes storing a third number of segments of the slice in the second storage device; the third number is based on a third weight, associated with the third storage device; the third weight is different from the first weight; and the third weight is different from the second weight.

In some embodiments, the processing circuit is further configured to implement a static mapping between a volume logical block address used by a file system of the host and a device logical block address used by the first storage device.

### BRIEF DESCRIPTION OF THE DRAWINGS

These and other features and advantages of the present disclosure will be appreciated and understood with reference to the specification, claims, and appended drawings wherein:

FIG. 1A is a block diagram of a host and a storage device, according to an embodiment of the present disclosure;

FIG. 1B is a system level block diagram, according to an embodiment of the present disclosure;

FIG. 1C is a block diagram of a storage device, according to an embodiment of the present disclosure;

FIG. 2A is a block diagram of a computing system, according to an embodiment of the present disclosure;

FIG. 2B is a block diagram of a computing system, according to an embodiment of the present disclosure;

FIG. 3A is a storage allocation diagram, according to an embodiment of the present disclosure;

FIG. 3B is a storage allocation diagram, according to an embodiment of the present disclosure;

FIG. 4A is a flowchart of a method, according to an embodiment of the present disclosure; and

FIG. 4B is a flowchart of a method, according to an embodiment of the present disclosure.

### DETAILED DESCRIPTION

The detailed description set forth below in connection with the appended drawings is intended as a description of exemplary embodiments of a system and method for weighted allocation to storage devices provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

In a computing system, a plurality of storage devices may be combined to form a composite storage device, which may be referred to as a storage unit, which may be connected to a host device (or “host”), and which may further include a storage management circuit for managing the storage devices. The storage unit may have the capability to store data in a plurality of volumes, each having a respective range of volume logical block addresses. The volumes may be allocated by the host device, and the mapping between volume logical block addresses and device logical block addresses may be static. In some embodiments, the allocation of volume logical block addresses is performed in a uniform round-robin manner, e.g., a range of volume logical block addresses to be mapped may be divided into segments, each segment including a set number of logical block addresses, and the segments may be allocated on the storage devices in a uniform round-robin fashion, e.g., each iteration of the uniform round-robin method may result in each of the storage devices having a respective segment allocated on it.

In a storage unit in which the storage devices do not all have the same size, e.g., the same storage capacity, a uniform round-robin method for assigning volume logical block addresses to device logical block addresses may cause the smallest storage device to have the greatest fill fraction. This smallest storage device may therefore experience the largest number of program/erase cycles per cell, and it may have the smallest proportion of unallocated storage capacity (which may be used for wear leveling (discussed in further detail below)). This may increase the risk of failure of smallest storage device and of the storage unit.

As such, the expected life of the storage unit may be increased by mapping the volume logical block addresses to the device logical block addresses in a manner that distributes the used storage capacity among the storage devices approximately or exactly in proportion to the respective storage capacities of the storage devices. For example, if a storage unit includes two storage devices, including a first storage device and a second storage device, and the first storage device has twice the capacity of the second storage device, then, if a range of 3,000 volume logical block addresses is to be allocated to device logical block addresses in the storage unit, 2,000 of the 3,000 volume logical block addresses may be allocated to the first storage device and 1,000 of the 3,000 volume logical block addresses may be allocated to the second storage device. This may result in the fill fraction being the same in the first storage device and in the second storage device, and it may cause the expected life of the first storage device and of the second storage device to be approximately the same.

Such an allocation method may be performed using a method referred to as a weighted round-robin method. In the weighted round-robin method, quantities of data referred to as segments are allocated on the storage devices of an array of storage devices, in a round-robin manner, with the number of segments allocated to each device per iteration of the weighted round-robin method being equal to a parameter that may be referred to as the “weight” of the storage device. For example, in a system with three storage devices, in which the weights are 1, 3, and 2, the weighted round-robin method may, in each iteration, allocated 1 segment on the first drive, 3 segments on the second drive, and 2 segments on the third drive. In some embodiments the weights may be selected based on other considerations (other than achieving an approximately uniform fill factor across the storage devices); for example, the weights may be selected so as to increase the fraction of data stored on a storage device that exhibits better performance.

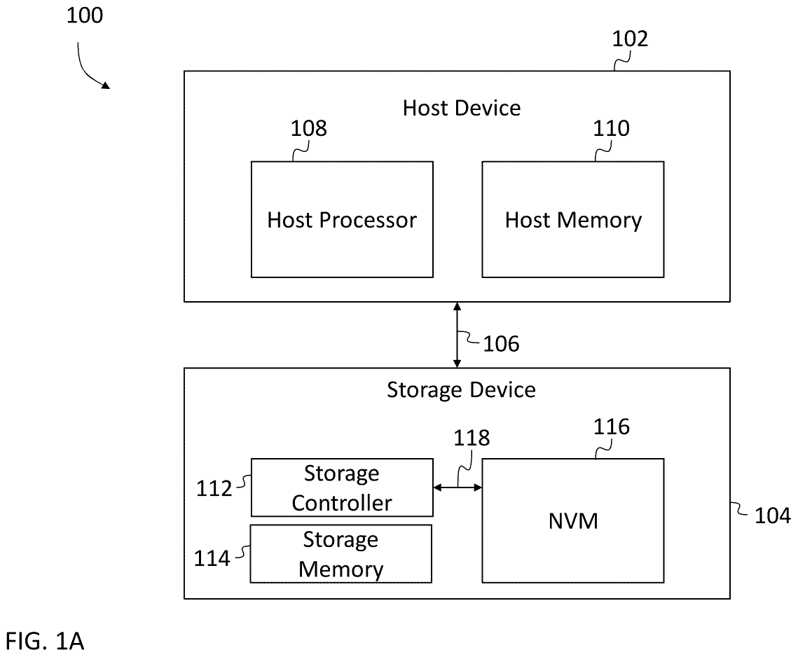

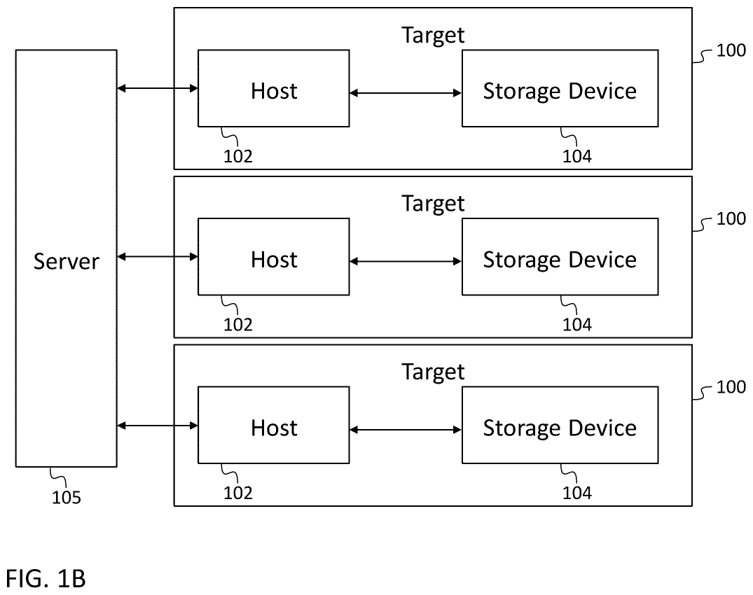

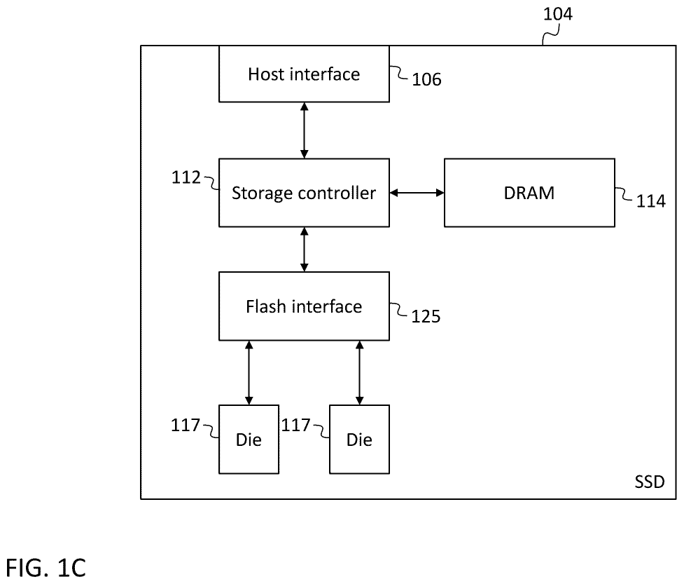

FIG. 1A illustrates a system, which may be referred to as a “target” 100, according to some embodiments of the present disclosure. Referring to FIG. 1A, the target 100 may include a host device 102 and a storage device 104 (which may be a persistent storage device 104). In some embodiments, the host device 102 may be housed with the storage device 104, and in other embodiments, the host device 102 may be separate from the storage device 104. The host device 102 may include any suitable computing device connected to a storage device 104 such as, for example, a personal computer (PC), a portable electronic device, a hand-held device, a laptop computer, or the like.

The host device 102 may be connected to the storage device 104 over a host interface 106. The host device 102 may issue data request commands or input-output (IO) commands (for example, read or write commands) to the storage device 104 over the host interface 106, and may receive responses from the storage device 104 over the host interface 106.

The host device 102 may include a host processor 108 and host memory 110. The host processor 108 may be a processing circuit (discussed in further detail below), for example, such as a general-purpose processor or a central processing unit (CPU) core of the host device 102. The host processor 108 may be connected to other components via an address bus, a control bus, a data bus, or the like. The host memory 110 may be considered as high performing main memory (for example, primary memory) of the host device 102. For example, in some embodiments, the host memory 110 may include (or may be) volatile memory, for example, such as dynamic random-access memory (DRAM). However, the present disclosure is not limited thereto, and the host memory 110 may include (or may be) any suitable high performing main memory (for example, primary memory) replacement for the host device 102 as would be known to those skilled in the art. For example, in other embodiments, the host memory 110 may be relatively high performing non-volatile memory, such as NAND flash memory, Phase Change Memory (PCM) (a type of memory that stores information using, in each memory cell, a change in resistance that accompanies a phase change in a material (e.g., a chalcogenide) in the cell), Resistive RAM (a type of memory in which a current through a controllable resistor (or “memristor”) changes its resistance, to store information), Spin-transfer Torque RAM (STTRAM) (a memory in which a spin-polarized current may be used to change the magnetization of a magnetic layer of a memory cell), any suitable memory based on PCM technology, or resistive random access memory (ReRAM), and may include, for example, or the like.

The storage device 104 may operate as secondary memory that may persistently store data accessible by the host device 102. In this context, the storage device 104 may include relatively slower memory when compared to the high performing memory of the host memory 110. For example, in some embodiments, the storage device 104 may be secondary memory of the host device 102, for example, such as a Solid-State Drive (SSD). However, the present disclosure is not limited thereto, and in other embodiments, the storage device 104 may include (or may be) any suitable storage device such as, for example, a magnetic storage device (for example, a hard disk drive (HDD), or the like), an optical storage device (for example, a Blue-ray disc drive, a compact disc (CD) drive, a digital versatile disc (DVD) drive, or the like), other kinds of flash memory devices (for example, a USB flash drive, and the like), or the like. In various embodiments, the storage device 104 may conform to a large form factor standard (for example, a 3.5-inch hard drive form-factor), a small form factor standard (for example, a 2.5 inch hard drive form-factor), an M.2 form factor, an E1.S form factor, or the like. In other embodiments, the storage device 104 may conform to any suitable or desired derivative of these form factors. For convenience, the storage device 104 may be described hereinafter in the context of a solid-state drive, but the present disclosure is not limited thereto.

The storage device 104 may be communicably connected to the host device 102 over the host interface 106. The host interface 106 may facilitate communications (for example, using a connector and a protocol) between the host device 102 and the storage device 104. In some embodiments, the host interface 106 may facilitate the exchange of storage requests (or “commands”) and responses (for example, command responses) between the host device 102 and the storage device 104. In some embodiments, the host interface 106 may facilitate data transfers by the storage device 104 to and from the host memory 110 of the host device 102. For example, in various embodiments, the host interface 106 (for example, the connector and the protocol thereof) may include (or may conform to) Small Computer System Interface (SCSI), Non Volatile Memory Express (NVMe), Peripheral Component Interconnect Express (PCIe), remote direct memory access (RDMA) over Ethernet, Serial Advanced Technology Attachment (SATA), Fiber Channel, Serial Attached SCSI (SAS), NVMe over Fabrics (NVMe-oF), or the like. In other embodiments, the host interface 106 (for example, the connector and the protocol thereof) may include (or may conform to) various general-purpose interfaces, for example, such as Ethernet, Universal Serial Bus (USB), and/or the like.

In some embodiments, the storage device 104 may include a storage controller 112, storage memory 114 (which may also be referred to as a buffer), non-volatile memory (NVM) 116, and a storage interface 118. The storage memory 114 may be high-performing memory of the storage device 104, and may include (or may be) volatile memory, for example, such as DRAM, but the present disclosure is not limited thereto, and the storage memory 114 may be any suitable kind of high-performing volatile or non-volatile memory. The non-volatile memory 116 may persistently store data received, for example, from the host device 102. The non-volatile memory 116 may include, for example, NAND flash memory, but the present disclosure is not limited thereto, and the non-volatile memory 116 may include any suitable kind of memory for persistently storing the data according to an implementation of the storage device 104 (for example, magnetic disks, tape, optical disks, or the like).

The storage controller 112 may be connected to the non-volatile memory 116 over the storage interface 118. In the context of the SSD, the storage interface 118 may be referred to as flash channel, and may be an interface with which the non-volatile memory 116 (for example, NAND flash memory) may communicate with a processing component (for example, the storage controller 112) or other device. Commands such as reset, write enable, control signals, clock signals, or the like may be transmitted over the storage interface 118. Further, a software interface may be used in combination with a hardware element that may be used to test or verify the workings of the storage interface 118. The software may be used to read data from and write data to the non-volatile memory 116 via the storage interface 118. Further, the software may include firmware that may be downloaded onto hardware elements (for example, for controlling write, erase, and read operations).

The storage controller 112 (which may be a processing circuit (discussed in further detail below)) may be connected to the host interface 106, and may manage signaling over the host interface 106. In some embodiments, the storage controller 112 may include an associated software layer (for example, a host interface layer) to manage the physical connector of the host interface 106. The storage controller 112 may respond to input or output requests received from the host device 102 over the host interface 106. The storage controller 112 may also manage the storage interface 118 to control, and to provide access to and from, the non-volatile memory 116. For example, the storage controller 112 may include at least one processing component embedded therein for interfacing with the host device 102 and the non-volatile memory 116. The processing component may include, for example, a general purpose digital circuit (for example, a microcontroller, a microprocessor, a digital signal processor, or a logic device (for example, a field programmable gate array (FPGA), an application-specific integrated circuit (ASIC), or the like)) capable of executing data access instructions (for example, via firmware or software) to provide access to the data stored in the non-volatile memory 116 according to the data access instructions. For example, the data access instructions may correspond to the data request commands, and may include any suitable data storage and retrieval algorithm (for example, read, write, or erase) instructions, or the like.

FIG. 1B is a system-level diagram, in some embodiments. Within each target 100, a host 102 is connected to a persistent storage device 104 (which may be, for example, a solid-state drive (SSD)). The persistent storage device 104 may have (as discussed above) a form factor that is any one of a plurality of form factors suitable for persistent storage devices, including but not limited to 2.5″, 1.8″, MO-297, MO-300, M.2, and Enterprise and Data Center SSD Form Factor (EDSFF), and it may have an electrical interface (which may be referred to as a “host interface”), through which it may be connected to the host 102, that is any one of a plurality of interfaces suitable for persistent storage devices, including Peripheral Component Interconnect (PCI), PCI express (PCIe), Ethernet, Small Computer System Interface (SCSI), Serial AT Attachment (SATA), and Serial Attached SCSI (SAS) or Universal Flash Storage (UFS). The persistent storage device 104 may include an interface circuit which operates as an interface adapter between the host interface 106 and one or more internal interfaces in the persistent storage device 104.

The host interface may be used by the host 102 to communicate with the persistent storage device 104, for example, by sending write and read commands, which may be received, by the persistent storage device 104, through the host interface. The host interface may also be used by the persistent storage device 104 to perform data transfers to and from system memory of the host 102.

Such data transfers may be performed using direct memory access (DMA). For example, when the host 102 sends a write command to the persistent storage device 104, the persistent storage device 104 may fetch the data to be written to the non-volatile memory 116 from the host memory 110 of the host device 102 using direct memory access, and the persistent storage device 104 may then save the fetched data to the non-volatile memory 116. Similarly, if the host 102 sends a read command to the persistent storage device 104, the persistent storage device 104 may read the requested data (i.e., the data specified in the read command) from the non-volatile memory 116 and save it in the host memory 110 of the host device 102 using direct memory access. The persistent storage device 104 may store data in a persistent memory, for example, not-AND (NAND) flash memory, for example, in memory dies containing memory cells, each of which may be, for example, a Single-Level Cell (SLC), a Multi-Level Cell (MLC), or a Triple-Level Cell (TLC).

A flash translation layer (FTL) (discussed in further detail below) of the persistent storage device 104 may provide a mapping between logical addresses (or “device logical block addresses”) used by the host 102 and physical addresses of the data in the persistent memory. The persistent storage device 104 may also include (i) a buffer which may include (for example, consist of) dynamic random-access memory (DRAM), and (ii) a persistent memory controller (for example, a flash controller) for providing suitable signals to the persistent memory. Some or all of the host interface, the flash translation layer, the buffer, and the persistent memory controller may be implemented in a processing circuit, which may be referred to as the persistent storage device controller.

FIG. 1C is a block diagram of a persistent storage device 104 (for example, a solid-state drive), in some embodiments. The host interface 106 is used by the host 102, to communicate with the persistent storage device 104. The data write and read input output commands, as well as various media management commands such as the Nonvolatile Memory Express (NVMe) Identify command and the NVMe Get Log command may be received, by the persistent storage device 104, through the host interface 106. In some embodiments, the storage device has an interface compatible with a different interface protocol, such as Small Computer System Interface (SCSI), Peripheral Component Interconnect Express (PCIe), Compute Express Link (CXL), remote direct memory access (RDMA) over Ethernet, Serial Advanced Technology Attachment (SATA), Fiber Channel, Serial Attached SCSI (SAS), NVMe over Fabrics (NVMe-oF), or the like. In such embodiments, commands that are similar, identical, or analogous to the Identify command or the Get Log command may be received by the persistent storage device 104, through the host interface 106. The host interface 106 may also be used by the persistent storage device 104 to perform data transfers to and from host system memory. The persistent storage device 104 may store data in non-volatile memory 116 (for example, not-AND (NAND) flash memory), for example, in memory dies 117 containing memory cells, each of which may be (as discussed above), for example, a Single-Level Cell (SLC), a Multi-Level Cell (MLC), or a Triple-Level Cell (TLC). A flash translation layer (FTL), which may be implemented in the storage controller 112 (for example, based on firmware (for example, based on firmware stored in the non-volatile memory 116) may provide a mapping between logical addresses used by the host and physical addresses of the data in the non-volatile memory 116. The persistent storage device 104 may also include (i) a buffer (for example, the storage memory 114) (which may include, for example, consist of, dynamic random-access memory (DRAM)), and (ii) a flash interface (or “flash controller”) 125 for providing suitable signals to the memory dies 117 of the non-volatile memory 116. Some or all of the host interface 106, the flash translation layer (as mentioned above), the storage memory 114 (for example, the buffer), and the flash interface 125 may be implemented in a processing circuit, which may be referred to as the persistent storage device controller 112 (or simply as the storage controller 112).

The NAND flash memory may be read or written at the granularity of a flash page, which may be between 4 kB and 16 kB in size. Before the flash memory page is reprogrammed with new data, it may first be erased. The granularity of an erase operation may be one NAND block, or “physical block”, which may include, for example, between 128 and 256 pages. Because the granularity of erase and program operations are different, garbage collection (GC) may be used to free up partially invalid physical blocks and to make room for new data. The garbage collection operation may (i) identify fragmented flash blocks, in which a large proportion (for example, most) of the pages are invalid, and (ii) erase each such physical block. When garbage collection is completed, the pages in an erased physical block may be recycled and added to a free list in the Flash Translation Layer.

The non-volatile memory 116 (for example, if it includes or is flash memory) may be capable of being programmed and erased only a limited number of times. This may be referred to as the maximum number of program/erase cycles (P/E cycles) the non-volatile memory 116 can sustain. To maximize the life of the persistent storage device 104, the persistent storage device controller 112 may endeavor to distribute write operations across all of the physical blocks of the non-volatile memory 116; this process may be referred to as wear leveling.

A mechanism that may be referred to as “read disturb” may reduce persistent storage device 104 reliability. A read operation on a NAND flash memory cell may cause the threshold voltage of nearby unread flash cells in the same physical block to change. Such disturbances may change the logical states of the unread cells, and may lead to uncorrectable error-correcting code (ECC) read errors, degrading flash endurance. To avoid this result, the Flash Translation Layer may have a counter of the total number of reads to a physical block since the last erase operation. The contents of the physical block may be copied to a new physical block, and the physical block may be recycled, when the counter exceeds a threshold (for example, 50,000 reads for Multi-Level Cell), to avoid irrecoverable read disturb errors. As an alternative, in some embodiments, a test read may periodically be performed within the physical block to check the error-correcting code error rate; if the error rate is close to the error-correcting code capability, the data may be copied to a new physical block.

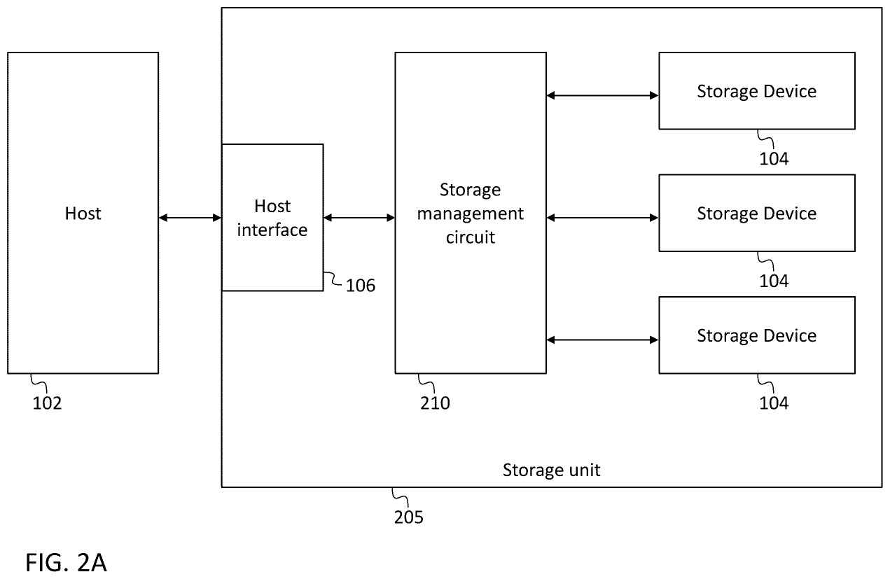

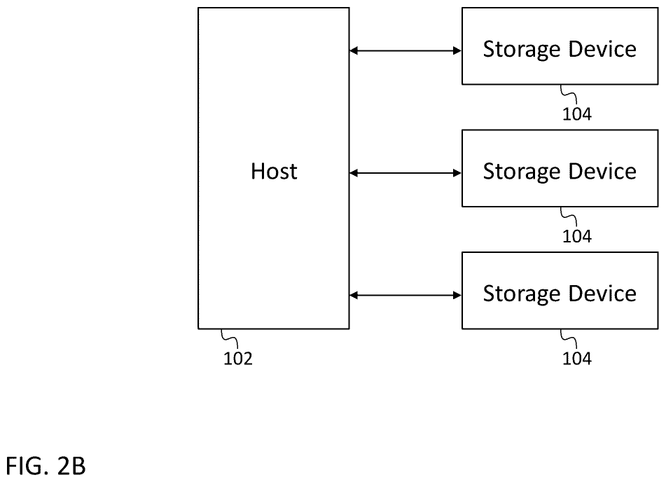

In some embodiments, as shown in FIG. 2A, a plurality of storage devices 104 may be combined to form a composite storage device, which may be referred to as a storage unit 205. The storage unit 205 may include a plurality of storage devices 104, e.g., two storage devices 104, or three storage devices 104 (as shown in FIG. 2A) or more than three storage devices 104. The storage unit 205 may further include a storage management circuit 210, which may be or include a processing circuit, and which may be or include a stored-program computer for managing the storage devices 104. In some embodiments, the storage management circuit 210 implements, or is connected to, a host interface 106, and from the perspective of the host device 102, the storage management circuit 210 may be indistinguishable from a single storage device having a storage capacity substantially equal to the sum of the storage capacities of the storage devices 104 of the storage unit 205. In some embodiments, the functions of the storage management circuit 210 are incorporated in the host device 102 and the storage devices 104 are connected directly to the host device 102, as shown in FIG. 2B. In such an embodiment, the functions of the storage management circuit 210 may be implemented as a software layer between the file system of the host device 102 and the driver or drivers of the storage devices 104.

The storage devices 104 of the storage unit 205 may be consumer-grade storage devices, e.g., flash memory devices (e.g., solid-state drives) in which the flash media are or include triple level cell (TLC) or quad level cell (QLC) flash memory cells. Such devices may be less costly to fabricate per unit of storage capacity but may have lower reliability than higher-grade (e.g., commercial grade) storage devices. The logical block addresses used by the storage devices 104 may be referred to as device logical block addresses. Each device logical block address may be the address of a corresponding unit of storage referred to as a device logical block and having a size referred to as the device logical block size.

The storage unit 205 may have the capability to store data in a plurality of volumes, each having a respective range of volume logical block addresses. Each volume logical block address may be the address of a corresponding unit of storage referred to as a volume logical block and having a size referred to as the volume logical block size. In some embodiments, the volume logical block size is an integer multiple of the device logical block size. In some embodiments, the device logical block size is an integer multiple of the volume logical block size.

In some embodiments in which the storage devices 104 are solid-state drives, each of the storage devices 104 of the storage unit 205 may (as discussed above) implement a mapping, using a flash translation layer, between (i) logical block addresses used at the external interface of the storage device 104 and (ii) physical addresses corresponding to the physical flash media in the storage device 104. The storage management circuit 210 may implement an additional mapping, between (i) the logical block addresses used at the interfaces of the storage devices 104 (which may be referred to as device logical block addresses) and (ii) logical block addresses used at the host interface 106 (which may be referred to as volume logical block addresses).

As mentioned above, the storage unit 205 may have the capability to store data in a plurality of volumes, each having a respective range of volume logical block addresses. The volumes may be allocated by the host device 102, and the mapping between volume logical block addresses and device logical block addresses may be static. In some embodiments, the allocation of volume logical block addresses is performed in a uniform round-robin manner, e.g., a range of volume logical block addresses to be mapped may be divided into segments, each segment having a segment number (with, e.g., the segments being consecutively numbered), and each segment including a set number of logical block addresses. The segments may be assigned to the storage devices 104 in a uniform round-robin fashion. The size of the segments may be arbitrary. In some embodiments, the segment size is selected to be smaller than the smallest one of the storage devices 104 (e.g., smaller than a fraction, between 0.001 and 0.1, of the size of the smallest one of the storage devices 104) and sufficiently large (e.g., larger than 500 bytes or larger than 1 MB) to avoid excessive overhead being incurred by the allocating of storage in units of segments. In some embodiments, the segment size is an integer multiple of the volume logical block size and the segment size is an integer multiple (not necessarily the same integer multiple) of the device logical block size.

Each sequence of allocations that (i) begins with an allocation to the first storage device 104, (ii) proceeds, in round-robin fashion, with an allocation to each subsequent storage device 104, and (iii) ends with an allocation to the last storage device 104 may be referred to as an iteration of the round-robin method. Allocating a large amount of space may require multiple iterations of the round-robin method. For example, in a storage unit 205 with three storage devices 104 (as illustrated in FIG. 2A), (i) in a first iteration, the first segment of a plurality of segments may be assigned to the first storage device 104 of the three storage devices 104, the second segment of the plurality of segments may be assigned to the second storage device 104 of the three storage devices 104, the third segment of the plurality of segments may be assigned to the third storage device 104 of the three storage devices 104, and, (ii) in a second iteration, the fourth segment of the plurality of segments may be assigned to the first storage device 104 of the three storage devices 104, the fifth segment of the plurality of segments may be assigned to the second storage device 104 of the three storage devices 104, and so forth.

As mentioned above, it may be that the storage devices do not all have the same size, e.g., the same storage capacity. In a system in which the storage unit 205 includes storage devices 104 having different respective storage capacities, a uniform round-robin method for assigning volume logical block addresses to device logical block addresses may cause the smallest storage device 104 to have the greatest fill fraction, where the “fill fraction” is the fraction of its storage capacity used. As used herein, a “uniform” round-robin method is a method that assigns the same number of segments (e.g., one segment) to each storage device 104 during each iteration. This smallest storage device 104 may therefore experience the largest number of program/erase cycles (P/E cycles) per cell, and it may have the smallest proportion of unallocated storage capacity (which may be used for wear leveling). As such, in such a system, the risk of failure may be greatest for the smallest storage device 104, and the expected life of the storage unit 205 may be determined primarily by, and limited by, the smallest storage device 104.

As such, the expected life of the storage unit 205 may be increased by mapping the volume logical block addresses to the device logical block addresses in a manner that distributes the used storage capacity among the storage devices 104 approximately or exactly in proportion to the respective storage capacities of the storage devices 104. For example, if a storage unit 205 includes two storage devices 104, including a first storage device 104 and a second storage device 104, and the first storage device 104 has twice the capacity of the second storage device 104, then, if a range of 3,000 volume logical block addresses is to be allocated to device logical block addresses in the storage unit 205, 2,000 of the 3,000 volume logical block addresses may be allocated to the first storage device 104 and 1,000 of the 3,000 volume logical block addresses may be allocated to the second storage device 104. This may result in the fraction of the storage capacity that is used being the same in the first storage device 104 and in the second storage device 104, and it may cause the expected life of the first storage device 104 and in the second storage device 104 to be approximately the same. Such an embodiment, and other embodiments disclosed herein, may result in an expected life of the storage system that is improved over otherwise similar systems that use, for example, a uniform round-robin method to allocate space; as such, embodiments in which the allocation is non-uniformly distributed over the storage devices 104 (such as embodiments using a weighted round-robin method) may improve the functioning of the computer itself, and they may also improve the technology of persistent storage systems.

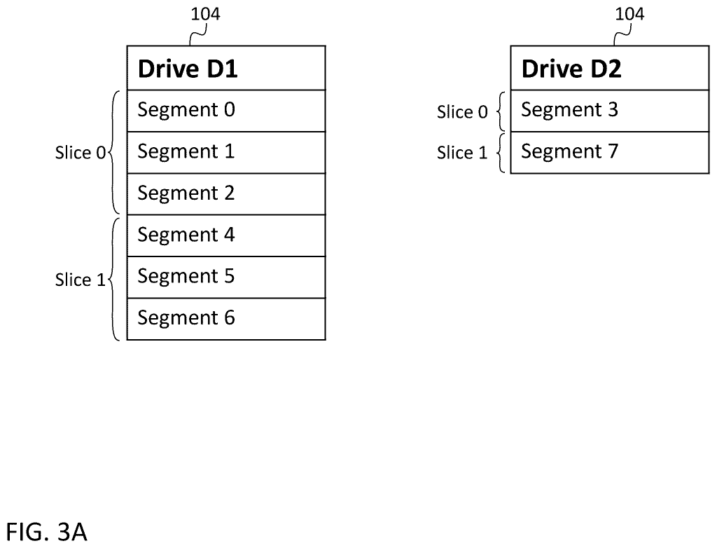

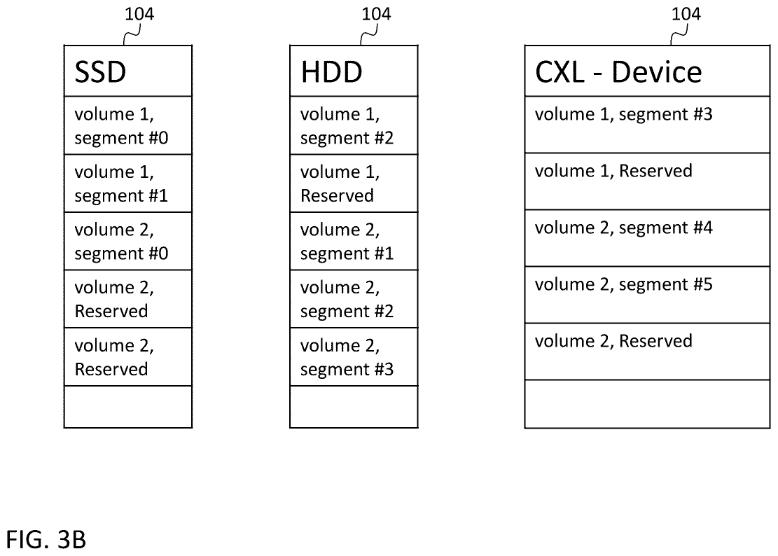

In some embodiments, such an unequal allocation of space on the storage devices 104 is accomplished using a weighted round-robin method. Space on the storage devices 104 is allocated, and filled, in units that may be referred to as slices, with each slice (i) corresponding to one iteration of the round-robin method, and (ii) including one or more segments on each of the storage devices 104. This is illustrated in FIG. 3A, in which a first storage device 104, referred to as Drive D1, has a storage capacity that is three times as great as the storage capacity of a second storage device 104, referred to as Drive D2. In the example of FIG. 3A, a first slice, e.g., Slice 0, includes segments 0 through 3 (three of which are allocated on the first storage device 104 (Drive D1), and one of which is allocated on the second storage device 104 (Drive D2)), and a second slice, e.g., Slice 1, includes segments 4 through 7 (three of which are allocated on the first storage device 104 (Drive D1), and one of which is allocated on the second storage device 104 (Drive D2)). Accordingly, in order to use similar fractions of the storage capacity as data is saved to the storage devices 104, three times as much storage space is allocated, for each slice, on the first storage device 104 (Drive D1) as on the second storage device 104 (Drive D2).

To accomplish the allocating and storing of data on the storage devices 104 in this manner, with space being used up at unequal rates as data is stored, a respective weight may be defined for each of the storage devices 104, and space may be allocated and filled on the storage devices 104 in proportion to the weights, using the weighted round-robin method. For example, in the embodiment of FIG. 3A, the first storage device 104 (Drive D1) may have a weight of three, and the second storage device 104 (Drive D2) may have a weight of one. As a stripe is written in the set of storage devices 104, each storage device 104 may have written to it a number of segments equal to the weight of the storage device 104. As such, the size of each stripe, in segments, may be equal to the sum of the weights of the storage devices 104.

Each weight may be an integer. In some embodiments, the size of the smallest weight is capped, so that an allocation is likely to include a plurality of weighted round-robin iterations, resulting in a distribution of the allocation across the storage devices 104 that is substantially in proportion to the weights. For example, in some embodiments, the capacities of the storage devices 104 are all multiplied by a number (e.g., a power of 10) such that the smallest weight is less than or equal to a cap (e.g., an integer cap between 2 and 1,000) and each quotient is then rounded to the nearest integer. For example, if the capacities of three storage devices 104, in a storage unit 205, are 128 gigabytes (GB), 250 GB and 500 GB, and if the cap on the smallest weight is 10, then the weights may be 10 (which is 128/12.8), 20 (which is 250/12.8, rounded to the nearest integer) and 39 (which is 500/12.8, rounded to the nearest integer).

In some embodiments, the capacity of each of the storage devices 104 is first divided by the lowest common multiple of the capacities of the storage devices 104 and then adjusted (e.g., multiplied by a power of 10 and rounded to the nearest integer) so that the smallest weight is an integer less than the cap. For example, if the capacities of three storage devices 104 in a storage unit 205, are 128 gigabytes (GB), 250 GB and 500 GB, and if the cap on the smallest weight is 10, the calculation of the weights may proceed as follows. First, the least common multiple of 128, 250, and 500 is found to be 16,000. The smallest capacity, 128, is divided by this least common multiple, resulting in 0.008. This number is then multiplied by a power of 10 (e.g., 1,000) to arrive at the value 8, which is already an integer, so that the rounding operation may be skipped. The scaling factor (the ratio of weight to capacity) for the smallest storage device 104 is then 8/128, which is 0.0625. The second weight is then calculated as round(0.0625×250) (where “round” signifies rounding to the nearest integer), which is 16, and the third weight is calculated as round(0.0625×500), which is 31. [Is the description in the preceding paragraph correct?]

For certain operations, e.g., when reading data, the storage management circuit 210 may translate a volume logical block address to (i) an identifier of the storage device 104 to which the volume logical block address is mapped (which may be referred to as the “device identifier” of the “target device”), and to a device logical block address within the target device. This translation may be performed by first identifying the storage device 104 within which the volume logical block address is mapped, which may be accomplished by (i) calculating the quotient Q and the remainder R, when the volume logical block address is divided by the number of volume logical blocks in a stripe, and then (ii) for each storage device 104, in the order in which the weighted round-robin method is performed, reducing the remainder by subtracting from the remainder, if it is possible to do so without obtaining a negative result, the number of volume logical blocks in N segments, where N is the weight of the storage device 104. This process will result in a new value for the remainder R, each time such a subtraction is performed. The storage device for which it is no longer possible to subtract the number of volume logical blocks in N segments (without obtaining a negative result), is the storage device 104 within which the volume logical block address is mapped, and, as such, this operation results in the device identifier of the target device. A globally unique segment number may be calculated by calculating a “ceiling volume logical block address”, which is equal to the volume logical block address that exceeds by one the greatest volume logical block address in the same segment as the volume logical block address being translated, and dividing the ceiling volume logical block address by the number of volume logical blocks per segment.

The device logical block address may be calculated as (1) Q times N times the number of device logical blocks per segment, plus (2) the last-calculated remainder times the ratio of (i) the number of device logical block addresses per segment to (ii) the number of volume logical block addresses per segment.

In some embodiments, the weights are selected in a different manner, e.g., for a purpose different from the purpose of arranging for the fill fraction of all of the storage devices 104 to be substantially the same. For example, as illustrated in FIG. 3B, in a storage unit 205 with a solid-state drive, a hard disk drive (or hard drive, or HDD) and a CXL device, the weights for a first volume may be assigned to be 2, 1, and 1, respectively, and the weights for a second volume may be assigned to be 1, 3, and 2, respectively. The effect, and purpose, of using such weights (weights equal to 2, 1, and 1, respectively) for the first volume may be to cause most of the data of the first volume to be served from the solid-state drive. The effect, and purpose, of using such weights (weights equal to 1, 3, and 2, respectively) for the second volume may be to preserve a greater proportion of the data on the hard disk drive than on the other storage devices 104. Space may be reserved in some or all of the volumes, and on some or all of the storage devices 104, as shown. Such reserved space may be used, for example, for wear leveling, on any storage device 104 (such as the solid-state drive) that uses flash memory as the storage medium.

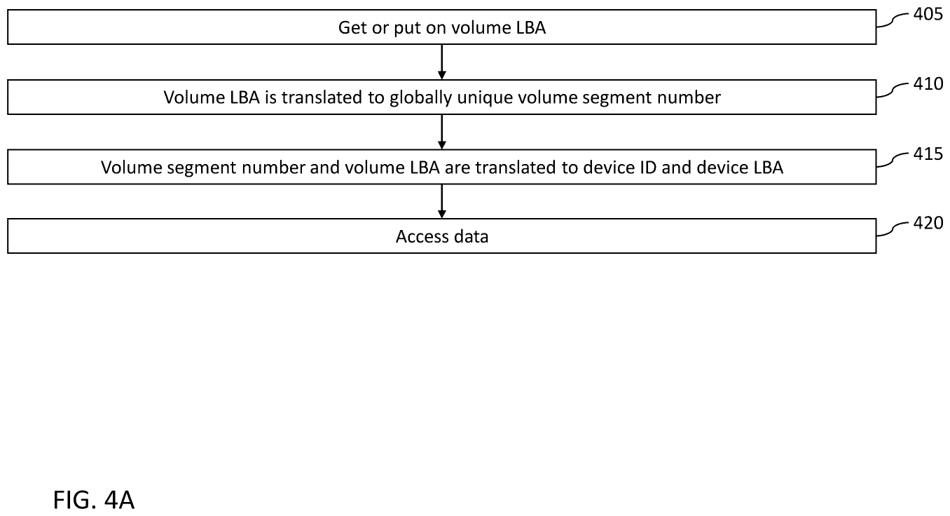

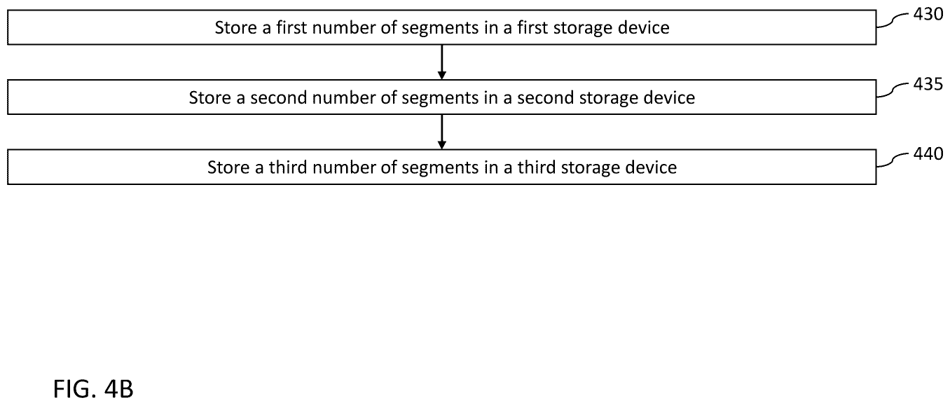

FIG. 4A is a flow chart of a data access operation, in some embodiments. Although FIG. 4A illustrates various operations in such a method, embodiments according to the present disclosure are not limited thereto. For example, according to some embodiments, such a method may include additional operations or fewer operations, or the order of operations may vary (unless otherwise explicitly stated or implied) without departing from the spirit and scope of embodiments according to the present disclosure. At 405, a get or put command for data within a volume is received from the host device 102 (e.g., from the file system of the host device 102) by the storage management circuit 210. The get or put command includes a volume logical block address identifying the location, within the volume, of the data to be accessed. The volume logical block address is translated, at 410 (e.g., by dividing the volume logical block address by the number of volume logical blocks per segment), into a globally unique segment number identifying the segment containing the data to be accessed, and, at 415, the volume segment number and the volume logical block address are translated to a device identifier and a device logical block address. The data access is then performed, at 420, using the device identifier and the device logical block address.

FIG. 4B is a flow chart of a method for storing a slice in a plurality of storage devices 104, in some embodiments. Although FIG. 4B illustrates various operations in such a method, embodiments according to the present disclosure are not limited thereto. For example, according to some embodiments, such a method may include additional operations or fewer operations, or the order of operations may vary (unless otherwise explicitly stated or implied) without departing from the spirit and scope of embodiments according to the present disclosure. The method includes storing (at 430) a first number of segments in a first storage device, storing (at 435) a second number of segments in the second storage device, and storing (at 440) a third number of segments in the second storage device. The number of segments stored in each storage device may depend on a weight of the storage device, e.g., it may be proportional to the weight of the storage device or equal to the weight of the storage device.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein “approximately” includes “exactly” as a special case, e.g., if A is equal to B then A is also approximately equal to B. As used herein, when a second quantity is “within Y” of a first quantity X, it means that the second quantity is at least X-Y and the second quantity is at most X+Y. As used herein, when a second number is “within Y %” of a first number, it means that the second number is at least (1−Y/100) times the first number and the second number is at most (1+Y/100) times the first number. As used herein, the term “or” should be interpreted as “and/or”, such that, for example, “A or B” means any one of “A” or “B” or “A and B”.

The background provided in the Background section of the present disclosure section is included only to set context, and the content of this section is not admitted to be prior art. Any of the components or any combination of the components described (e.g., in any system diagrams included herein) may be used to perform one or more of the operations of any flow chart included herein. Further, (i) the operations are example operations, and may involve various additional operations not explicitly covered, and (ii) the temporal order of the operations may be varied.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that such spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1−35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

It will be understood that when an element is referred to as being “directly connected” or “directly coupled” to another element, there are no intervening elements present. As used herein, “generally connected” means connected by an electrical path that may contain arbitrary intervening elements, including intervening elements the presence of which qualitatively changes the behavior of the circuit. As used herein, “connected” means (i) “directly connected” or (ii) connected with intervening elements, the intervening elements being ones (e.g., low-value resistors or inductors, or short sections of transmission line) that do not qualitatively affect the behavior of the circuit.

Some embodiments may include features of the following numbered statements.
1. A method, comprising:
storing a slice in a storage system, the storage system comprising a first storage device and a second storage device,
the storing of the slice comprising:
   storing a first number of segments of the slice in the first storage device, and
   storing a second number of segments of the slice in the second storage device,
the first number being based on a first weight, associated with the first storage device,
the second number being based on a second weight, associated with the second storage device, and
the second weight being different from the first weight.
2. The method of statement 1, wherein a ratio of the second number to the first number is equal to a ratio of the second weight to the first weight.
3. The method of statement 1 or statement 2, wherein a ratio of the first weight to the second weight is within 20% of a ratio of a size of the first storage device to a size of the second storage device.
4. The method of any one of the preceding statements, wherein the storage system is a statically mapped storage system.
5. The method of any one of the preceding statements, wherein:
the first storage device has a first size,
the second storage device has a second size; and
the second size is greater than 1.5 times the first size.
6. The method of any one of the preceding statements, wherein the first storage device comprises a first storage medium, and the second storage device comprises a second storage medium different from the first storage medium.
7. The method of any one of the preceding statements, wherein:
the storage system further comprises a third storage device;
the storing of the slice further comprises storing a third number of segments of the slice in the second storage device;
the third number is based on a third weight, associated with the third storage device;
the third weight is different from the first weight; and
the third weight is different from the second weight.
8. A system, comprising:
a storage control circuit;
a first storage device; and
a second storage device,
the storage control circuit having a host interface for making a connection to a host,
the storage control circuit being configured to store a slice,
the storing of the slice comprising:
   storing a first number of segments of the slice in the first storage device, and
   storing a second number of segments of the slice in the second storage device,
the first number being based on a first weight, associated with the first storage device,
the second number being based on a second weight, associated with the second storage device, and
the second weight being different from the first weight.
9. The system of statement 8, wherein a ratio of the second number to the first number is equal to a ratio of the second weight to the first weight.
10. The system of statement 8 or statement 9, wherein a ratio of the first weight to the second weight is within 20% of a ratio of a size of the first storage device to a size of the second storage device.
11. The system of any one of statements 8 to 10, wherein:
the first storage device has a first size,
the second storage device has a second size; and
the second size is greater than 1.5 times the first size.
12. The system of any one of statements 8 to 11, wherein the first storage device comprises a first storage medium, and the second storage device comprises a second storage medium different from the first storage medium.
13. The system of any one of statements 8 to 12, further comprising a third storage device,
wherein:
   the storing of the slice further comprises storing a third number of segments of the slice in the second storage device;
   the third number is based on a third weight, associated with the third storage device;
   the third weight is different from the first weight; and
   the third weight is different from the second weight.
14. A system, comprising:
a host;
a first storage device; and
a second storage device,
the host comprising a processing circuit,
the processing circuit being configured to store a slice,
the storing of the slice comprising:
   storing a first number of segments of the slice in the first storage device, and
   storing a second number of segments of the slice in the second storage device,
the first number being based on a first weight, associated with the first storage device,
the second number being based on a second weight, associated with the second storage device, and
the second weight being different from the first weight.
15. The system of statement 14, wherein a ratio of the second number to the first number is equal to a ratio of the second weight to the first weight.
16. The system of statement 14 or statement 15, wherein a ratio of the first weight to the second weight is within 20% of a ratio of a size of the first storage device to a size of the second storage device.
17. The system of any one of statements 14 to 16, wherein:
the first storage device has a first size,
the second storage device has a second size; and
the second size is greater than 1.5 times the first size.
18. The system of one of statements 14 to 17, wherein the first storage device comprises a first storage medium, and the second storage device comprises a second storage medium different from the first storage medium.
19. The system of one of statements 14 to 18, further comprising a third storage device,
wherein:
   the storing of the slice further comprises storing a third number of segments of the slice in the second storage device;
   the third number is based on a third weight, associated with the third storage device;
   the third weight is different from the first weight; and
   the third weight is different from the second weight.
20. The system of one of statements 14 to 19, wherein the processing circuit is further configured to implement a static mapping between a volume logical block address used by a file system of the host and a device logical block address used by the first storage device.

Although exemplary embodiments of a system and method for weighted allocation to storage devices have been specifically described and illustrated herein, many modifications and variations will be apparent to those skilled in the art. Accordingly, it is to be understood that a system and method for weighted allocation to storage devices constructed according to principles of this disclosure may be embodied other than as specifically described herein. The invention is also defined in the following claims, and equivalents thereof.

What is claimed is:

1. A method, comprising:
storing a slice in a storage system, the storage system comprising a first storage device and a second storage device,
the storing of the slice comprising:
storing a first number of segments of the slice in the first storage device, and
storing a second number of segments of the slice in the second storage device,
the first number being based on a first weight, associated with the first storage device,
the second number being based on a second weight, associated with the second storage device, and
the second weight being different from the first weight.

2. The method of claim 1, wherein a ratio of the second number to the first number is equal to a ratio of the second weight to the first weight.

3. The method of claim 1, wherein a ratio of the first weight to the second weight is within 20% of a ratio of a size of the first storage device to a size of the second storage device.

4. The method of claim 1, wherein the storage system is a statically mapped storage system.

5. The method of claim 1, wherein:
the first storage device has a first size,
the second storage device has a second size; and
the second size is greater than 1.5 times the first size.

6. The method of claim 1, wherein the first storage device comprises a first storage medium, and the second storage device comprises a second storage medium different from the first storage medium.

7. The method of claim 1, wherein:
the storage system further comprises a third storage device;
the storing of the slice further comprises storing a third number of segments of the slice in the second storage device;
the third number is based on a third weight, associated with the third storage device;
the third weight is different from the first weight; and
the third weight is different from the second weight.

8. A system, comprising:
a storage control circuit;
a first storage device; and
a second storage device,
the storage control circuit having a host interface for making a connection to a host,
the storage control circuit being configured to store a slice,
the storing of the slice comprising:
storing a first number of segments of the slice in the first storage device, and
storing a second number of segments of the slice in the second storage device,
the first number being based on a first weight, associated with the first storage device,
the second number being based on a second weight, associated with the second storage device, and
the second weight being different from the first weight.

9. The system of claim 8, wherein a ratio of the second number to the first number is equal to a ratio of the second weight to the first weight.

10. The system of claim 8, wherein a ratio of the first weight to the second weight is within 20% of a ratio of a size of the first storage device to a size of the second storage device.

11. The system of claim 8, wherein:
the first storage device has a first size,
the second storage device has a second size; and
the second size is greater than 1.5 times the first size.

12. The system of claim 8, wherein the first storage device comprises a first storage medium, and the second storage device comprises a second storage medium different from the first storage medium.

13. The system of claim 8, further comprising a third storage device,
wherein:
the storing of the slice further comprises storing a third number of segments of the slice in the second storage device;
the third number is based on a third weight, associated with the third storage device;
the third weight is different from the first weight; and
the third weight is different from the second weight.

14. A system, comprising:
a host;
a first storage device; and
a second storage device,
the host comprising a processing circuit,
the processing circuit being configured to store a slice,
the storing of the slice comprising:
storing a first number of segments of the slice in the first storage device, and
storing a second number of segments of the slice in the second storage device,
the first number being based on a first weight, associated with the first storage device,
the second number being based on a second weight, associated with the second storage device, and
the second weight being different from the first weight.

15. The system of claim 14, wherein a ratio of the second number to the first number is equal to a ratio of the second weight to the first weight.

16. The system of claim 14, wherein a ratio of the first weight to the second weight is within 20% of a ratio of a size of the first storage device to a size of the second storage device.

17. The system of claim 14, wherein:
the first storage device has a first size,
the second storage device has a second size; and
the second size is greater than 1.5 times the first size.

18. The system of claim 14, wherein the first storage device comprises a first storage medium, and the second storage device comprises a second storage medium different from the first storage medium.

19. The system of claim 14, further comprising a third storage device,
wherein:
the storing of the slice further comprises storing a third number of segments of the slice in the second storage device;
the third number is based on a third weight, associated with the third storage device;
the third weight is different from the first weight; and
the third weight is different from the second weight.

20. The system of claim 14, wherein the processing circuit is further configured to implement a static mapping between a volume logical block address used by a file system of the host and a device logical block address used by the first storage device.
